(19) United States
(12) Patent Application Publication
(10) Pub. No.: US 2017/0050606 A1
(43) Pub. Date: Feb. 23, 2017

(54) AUTOMOBILE AIRBAG DOOR

(71) Applicant: TOYODA GOSEI CO., LTD., Kiyosu-shi (JP)

(72) Inventors: Shunta ASAKUMA, Kiyosu-shi (JP); Chiharu TOTANI, Kiyosu-shi (JP); Minoru TODA, Kiyosu-shi (JP); Etsuo OZAWA, Kiyosu-shi (JP)

(21) Appl. No.: 15/228,020

(22) Filed: Aug. 4, 2016

(30) Foreign Application Priority Data
Aug. 21, 2015 (JP) 2015-163688

(51) Int. Cl. B60R 21/2165; B60R 13/00

(52) U.S. Cl. CPC B60R 21/2165; B60R 13/00; B60R 21/205

(57) ABSTRACT

An automobile airbag door includes a base member, a cover member, which is bonded to the surface of the base member, and a tear line, which is formed in the back side of the base member. The tear line is configured to be a starting point of tearing when the base member is pressed by an airbag being deployed and inflated. The cover member includes a three-dimensionally knitted cushion layer. The three-dimensionally knitted cushion layer includes a top-side knitted fabric layer, a back-side knitted fabric layer bonded to the surface of the base member, and a connection layer, which is configured by connecting strands connecting the back-side knitted fabric layer and the top-side knitted fabric layer to each other. The mass per unit area of the back-side knitted fabric layer is set to be in the range from 150 g/m² to 300 g/m².

### BACKGROUND OF THE INVENTION

The present invention relates to an automobile airbag door that is opened when torn by pressing force of an airbag being deployed and inflated.

Conventionally, an automobile is equipped with a front passenger seat airbag apparatus as a means for protecting the occupant on the front passenger seat (for example, refer to Japanese National Phase Laid-Open Patent Publication No. 2005-537164). In the front passenger seat airbag apparatus, a part of the instrument panel arranged in front of the front passenger seat of the automobile forms an airbag door. The airbag door includes a base member, which serves as a core member, and a cover member bonded to the surface of the base member. The cover member includes a cushion layer bonded to the surface of the base member and a covering bonded to the surface of the cushion layer. The covering includes a ground fabric layer and a covering layer bonded to the surface of the ground fabric layer.

Some airbag doors have a three-dimensionally knitted cushion layer, which is, for example, configured by double-raschel knitted fabric, to give elasticity to the airbag door, thereby improving the tactile sensation.

The airbag door has a tear line (a tearable line), which is formed by a plurality of short cleavage grooves or a single elongated cleavage groove and functions as the starting point of tearing leading to an opening action. The tear line allows the airbag door to be smoothly opened and the airbag to be smoothly deployed and inflated. To be inconspicuous from the surface side of the airbag door, the tear line is formed on the back side of the airbag door. For example, a tear line is formed in each of the base member and the cushion layer. In addition to the tear lines formed in the base member and the cushion layer, some airbag doors are also provided with a tear line formed in the back side of the covering.

When an impact is applied from the front to an automobile equipped with the above described front passenger seat airbag apparatus, for example, due to a frontal collision, the inflator supplies inflation gas to the airbag to deploy and inflate the airbag. The airbag in turn presses the airbag door, thereby tearing the base member and the cover member along the tear lines to open the airbag door. The airbag passes through the opening, which is formed by opening the airbag door, to be deployed and inflated between the instrument panel and the occupant seated on the front passenger seat, thereby reducing the impact applied to the occupant from the front.

If a three-dimensionally knitted cushion layer made of, for example, double-raschel knitted fabric is used as the cushion layer forming a cover member, the adhesive for bonding the surface of the base member and the back of the three-dimensionally knitted cushion layer to each other is likely to leak to the surface side of the three-dimensionally knitted cushion layer through apertures of the mesh. This may change the elasticity of the three-dimensionally knitted cushion layer and degrade the cushioning property.

### SUMMARY OF THE INVENTION

Accordingly, it is an objective of the present invention to provide an automobile airbag door, which restrains degradation of the cushioning property of the cover member due to leakage of adhesive and allows the cover member to be stably torn when the airbag apparatus is activated.

To achieve the foregoing objective, an automobile airbag door is provided that includes a base member having a surface and a back side, a cover member, which is bonded to the surface of the base member, and a tear line formed in the back side of the base member. The tear line is configured to be a starting point of tearing when the base member is pressed by an airbag being deployed and inflated. The cover member includes a three-dimensionally knitted cushion layer. The three-dimensionally knitted cushion layer includes a top-side knitted fabric layer, a back-side knitted fabric layer, which is bonded to the surface of the base member, and a connection layer, which is configured by connecting strands connecting the back-side knitted fabric layer and the top-side knitted fabric layer to each other. Amass per unit area of the back-side knitted fabric layer is set to be in a range from 150 g/m² to 300 g/m².

### BRIEF DESCRIPTION OF THE DRAWINGS

FIG. 1 is a diagram of an automobile airbag door according to one embodiment, showing a perspective view of an instrument panel in which a front passenger seat airbag apparatus is mounted.

FIG. 2 is a schematic plan view showing a state of the front passenger seat airbag apparatus of the embodiment, illustrating a state in which the airbag is deployed and inflated to protect the occupant on the front passenger seat.

FIG. 3 is a partial plan view of the airbag door and its surroundings in the instrument panel of the embodiment.

FIG. 4 is a partial cross-sectional view taken along line 4-4 of FIG. 3, illustrating the airbag apparatus.

FIG. 5 is a partial cross-sectional view of section X of FIG. 4.

FIG. 6 is a diagram showing the anisotropy in the tensile strength of the three-dimensionally knitted cushion layer of the embodiment.

FIG. 7A is a photograph showing the surface of the three-dimensionally knitted cushion layer of FIG. 6.

FIG. 7B is a photograph showing the back of the three-dimensionally knitted cushion layer of FIG. 6.

FIG. 8 is a partial plan view of the back of the base member of the embodiment, showing a part in which a tear line is formed.

FIG. 9 is a partial plan view of the surface of the three-dimensionally knitted cushion layer of FIG. 6, showing the part in which the tear line is formed.

FIG. 10A is a photograph showing the surface of a three-dimensionally knitted cushion layer of a modification.

FIG. 10B is a photograph showing the back of the three-dimensionally knitted cushion layer of FIG. 10A.

### DETAILED DESCRIPTION OF THE PREFERRED EMBODIMENTS

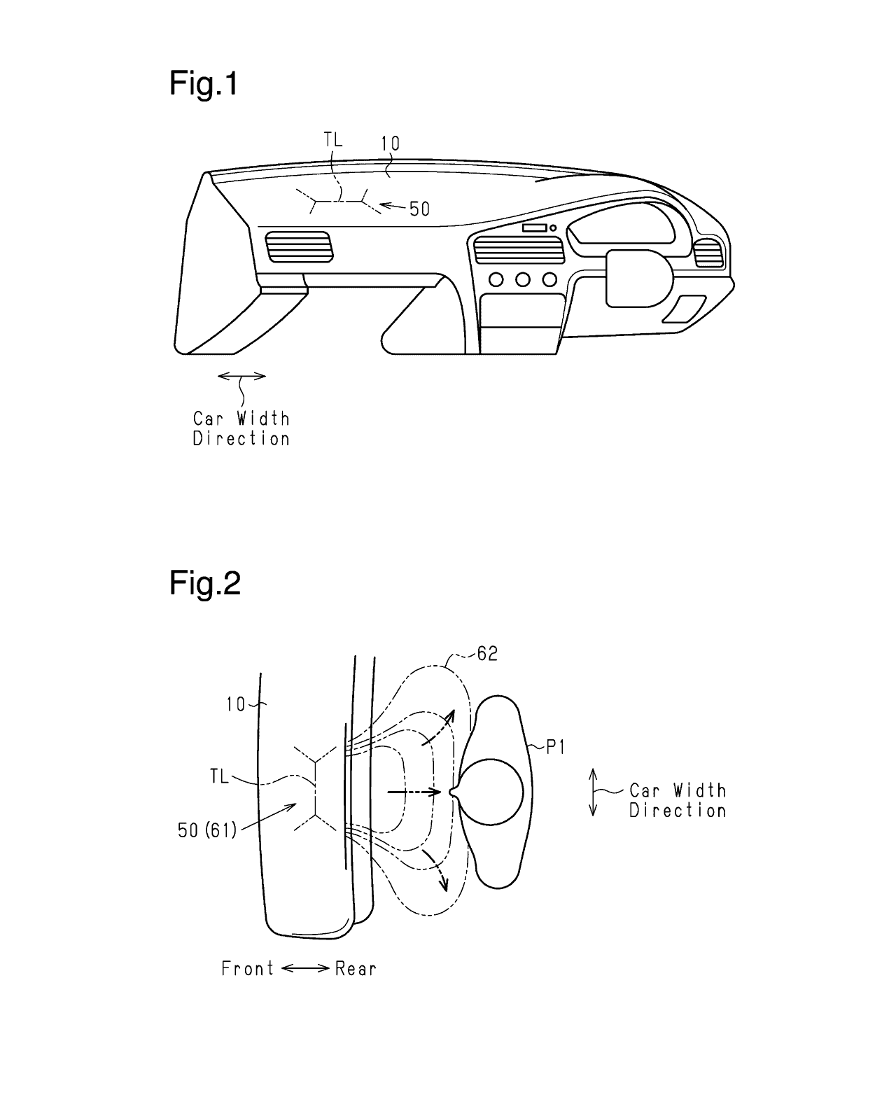

One embodiment will now be described with reference to FIGS. 1 to 9. In the following description, the advancing direction of the automobile is defined as a forward direction. The rearward, upward, downward, leftward, and rightward directions are defined with reference to the forward direction. Thus, the left-right direction agrees with the width direction of the automobile (car width direction).

As shown in FIGS. 1 and 2, an automobile includes an instrument panel 10, which extends along the width of the automobile and is arranged forward of the driver's seat and the front passenger seat.

The automobile has a front passenger seat airbag apparatus (hereinafter, referred to as an airbag apparatus 61), which inflates and deploys an airbag 62 forward of an occupant P1 seated on the front passenger seat to protect the occupant P1 from an impact when the impact is applied from the front.

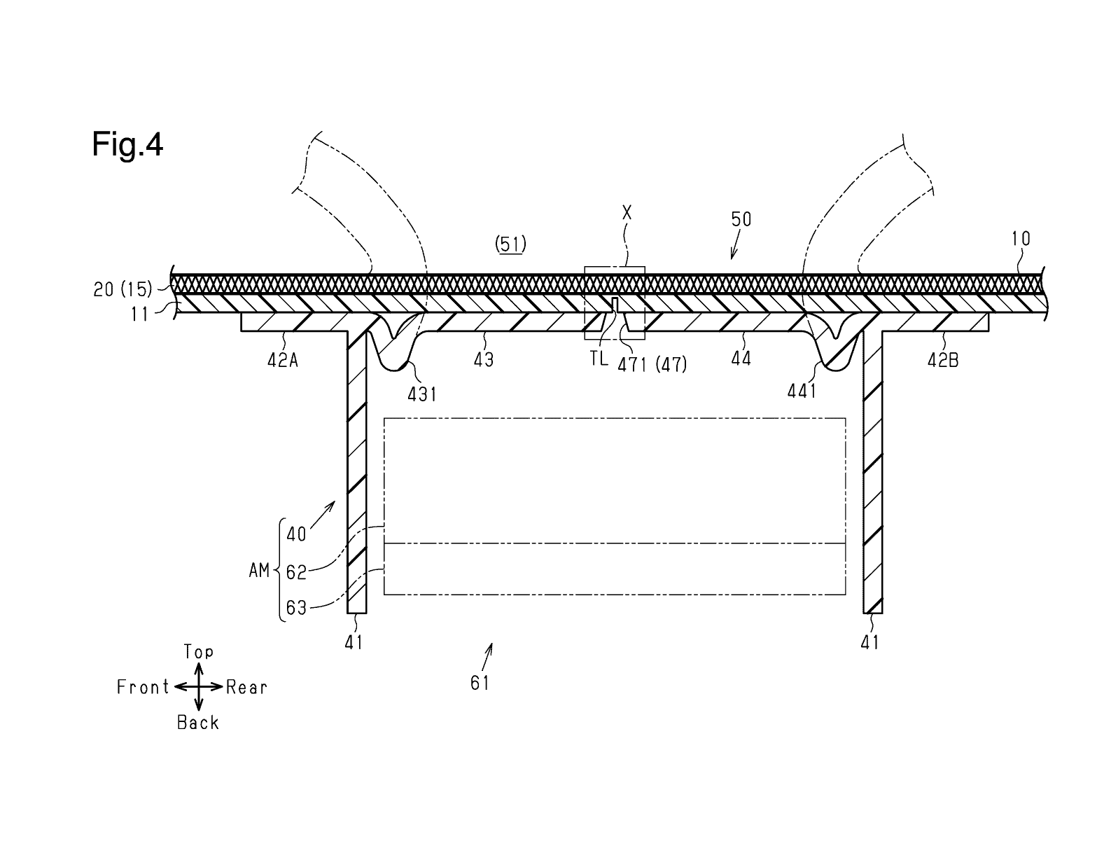

As shown in FIG. 4, the airbag apparatus 61 has an automobile airbag door (hereinafter, referred to as an airbag door 50), which is formed in a part of the instrument panel 10 forward of the front passenger seat, and an airbag module AM, which is located on the back side of the airbag door 50. When the airbag apparatus 61 is activated, the airbag door 50 is pressed by the airbag 62 being deployed and inflated and is opened toward the front passenger seat, thereby defining an opening 51, which allows the airbag 62 to be deployed.

### <Regarding Basic Structure of Airbag Door 50>

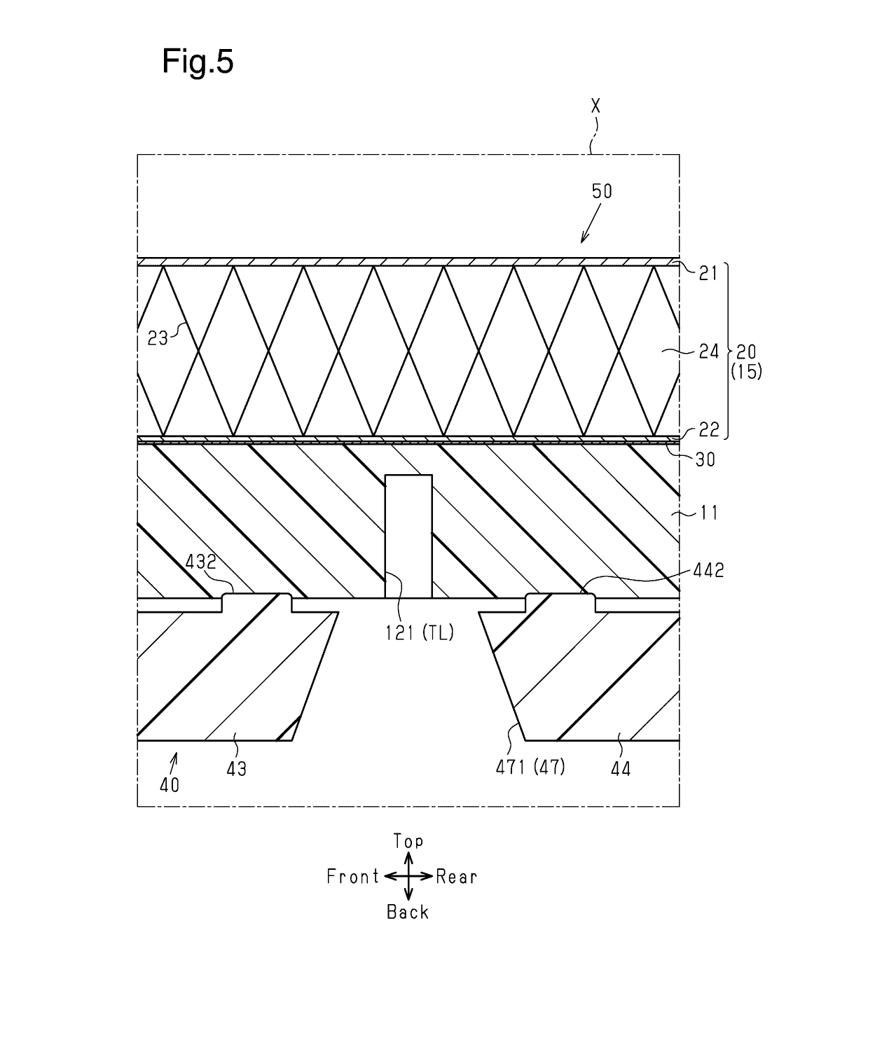

As shown in FIGS. 4 and 5, the airbag door 50 includes a base member 11, which is a core member, and a cover member 15.

The base member 11 is made of a plastic such as thermoplastic olefin (TPO) or polypropylene by injection molding. The base member 11, for example, has a thickness of 2.5 to 3.5 mm.

The cover member 15 is constituted solely by a three-dimensionally knitted cushion layer 20, which is bonded to the surface of the base member 11 with an adhesive 30. Thus, the surface of the three-dimensionally knitted cushion layer 20 constitutes the ornamental surface of the cover member 15. That is, the surface of the three-dimensionally knitted cushion layer 20 constitutes the ornamental surface of the airbag door 50.

The three-dimensionally knitted cushion layer 20 is used to give a required cushioning property (elasticity) to the airbag door 50, thereby improving the tactile sensation. The three-dimensionally knitted cushion layer 20 is, for example, configured by a three-dimensionally knitted fabric such as a double-raschel knitted fabric.

The three-dimensionally knitted cushion layer 20 includes a top-side knitted fabric layer 21, a back-side knitted fabric layer 22, and a connection layer 24, and is formed by a double-raschel machine.

As in one example shown in FIG. 7A, the top-side knitted fabric layer 21 is structured by a single yarn and formed by planar and regularly arranged mesh pattern. The top-side knitted fabric layer 21 constitutes an ornamental surface of the cover member 15.

As in one example shown in FIG. 7B, the back-side knitted fabric layer 22 is structured by a single yarn and formed by planar and regularly arranged mesh pattern.

The top-side knitted fabric layer 21 and the back-side knitted fabric layer 22 are configured by yarns of synthetic fibers such as polyester fibers, polyamide fibers, acrylic fibers, and polypropylene fibers, natural fibers such as cotton, linen, and wool, and regenerated fibers such as cuprammonium rayon and lyocell.

The knitted fabric structure of the top-side knitted fabric layer 21 has a rectangular or hexagonal mesh structure. The back-side knitted fabric layer 22 has a flat knitted fabric structure. For example, the knitted fabric structure of the back-side knitted fabric layer 22 is tricot knitting, cord knitting, or atlas knitting, which are three basic knit constructions of warp knitting.

The connection layer 24 is configured by connecting strands 23 that connect the top-side knitted fabric layer 21 and the back-side knitted fabric layer 22. The connecting strands 28 are configured by polytrimethylene terephthalate fibers, polyethylene terephthalate fibers, polybutylene terephthalate fibers, polyamide fibers, polyvinyl chloride fibers, or polyester-based elastomer fibers. In order to maintain a good long-lasting cushioning property after repetitive or long-time compressions of the three-dimensionally knitted cushion layer 20, it is preferable that polytrimethylene terephthalate fibers be used for at least a part of the connecting strands 23. The cross-sectional shape of the fibers preferably has a round cross-sectional shape in view of maintaining a good cushioning property for a long time. Further, monofilament yarns are preferably used for connecting strands 23 in view of restraining displacement force.

The connecting strands 23 may form loop-shaped stitches in the knitted fabrics of the top-side knitted fabric layer 21 and the back-side knitted fabric layer 22. Further, the connecting strands 23 may be hooked to both knitted fabric layers 21 and 22 using insertion stitches or tuck stitches. In particular, it is preferable that at least two connecting strands 23 inclined obliquely in opposite directions to connect the knitted fabric layers 21 and 22 in a crossing (X-shaped) structure or a truss structure in view of improving the shape stability of the cushion layer 20 and providing a favorable cushioning property. A truss structure is a structural form constituted by an aggregation of triangular basic units. Substantially triangular shapes are formed by the connecting strands 23 and the top-side knitted fabric layer 21 and by the connecting strands 23 and the back-side knitted fabric layer 22. In this case, each connecting strand 23 may be constituted by two threads in a crossing structure or a truss structure. Further, each connecting strand 23 may be constituted by a single thread, and the connecting strand 23 may be folded back at the top-side knitted fabric layer 21 and the back-side knitted fabric layer 22, resulting in a seemingly two-threaded structure.

Having no layered structure, the above described three-dimensionally knitted cushion layer 20 is excellent in breathability and cushioning property, for example. The thickness of the three-dimensionally knitted cushion layer 20 may be changed by adjusting the lengths of the connecting strands 23. In the present embodiment, the three-dimensionally knitted cushion layer 20 is formed to have a thickness of 2.5 mm or more.

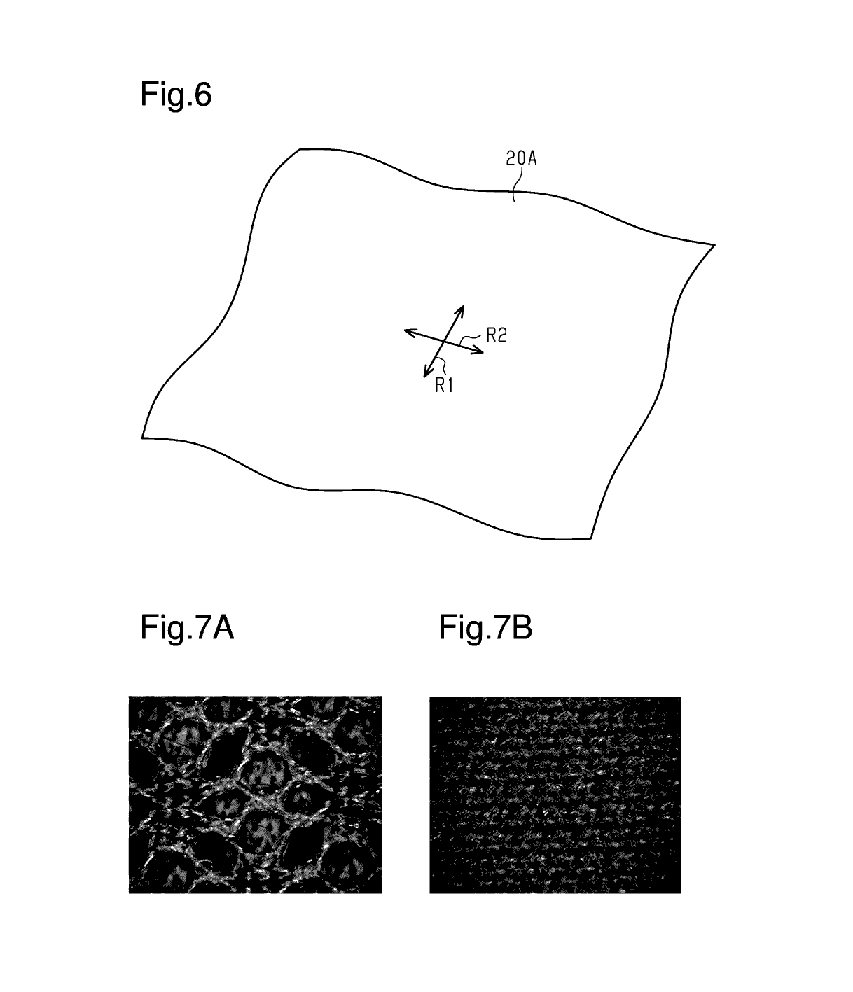

As shown in FIG. 6, an original fabric 20A of the three-dimensionally knitted cushion layer 20 has anisotropic tensile strength in directions along the surface. That is, the tensile strength of the original fabric 20A is set to be the smallest in a specific direction R1 along the surface and is set to be the greatest in another direction R2, which is perpendicular to the direction R1.

### <Regarding General Structure of Airbag Module AM>

As shown in FIG. 4, a retainer 40 is provided on the back side of the airbag door 50. The retainer 40 has front-side and rear-side wall portions 41, which are arranged in the front-rear direction to face each other with a space in between, and left-side and right-side wall portions (not shown), which are arranged in the car width direction to face each other with a space in between. The front-side and rear-side wall portions 41 hold the airbag 62 in a folded state and an inflator 63 for generating and supplying inflation gas to the airbag 62. The retainer 40, the airbag 62, and the inflator 63 constitute the airbag module AM.

As shown in FIG. 4, a first extended portion 42A, which extends forward along the back of the airbag door 50, and a front-side door portion 43, which extends rearward via a first hinge portion 431, are coupled to the top-side end of the front-side wall portion 41. A second extended portion 42B, which extends rearward along the back of the airbag door 50, and a rear-side door portion 44, which extends forward via a second hinge portion 441, are coupled to the top-side end of the rear-side wall portion 41.

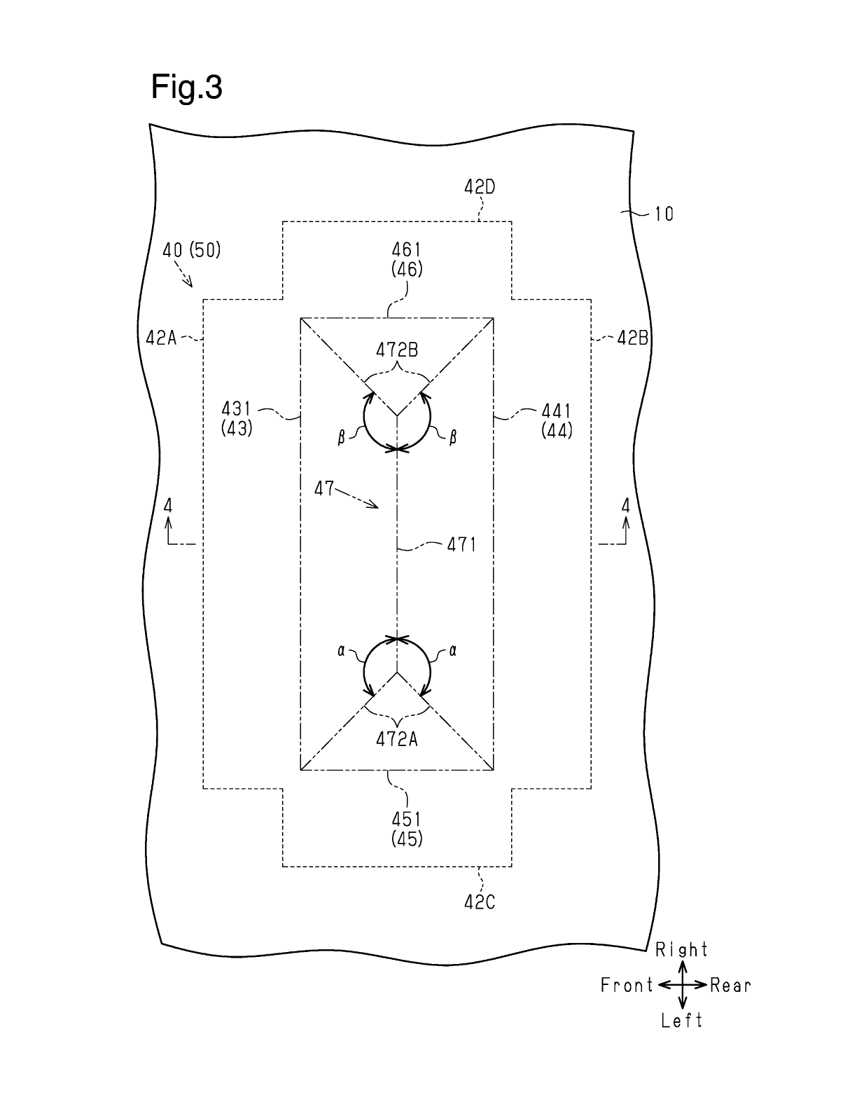

As shown in FIGS. 3 and 4, a first groove 471 of a through-groove 47, which extends in the car width direction, is located between the front-side door portion 43 and the rear-side door portion 44.

As shown in FIG. 3, a third extended portion 42C and a left-side door portion 45 are coupled to the top-side end of the left-side wall portion (not shown) . The third extended portion 42C extends leftward along the back of the airbag door 50, and the left-side door portion 45 extends rightward via a third hinge portion 451. A fourth extended portion 42D, which extends rightward along the back of the airbag door 50, and a right-side door portion 46, which extends leftward via a fourth hinge portion 461, are coupled to the top-side end of the right-side wall portion (not shown).

A pair of V-shaped second grooves 472A is formed on the left end of the first groove 471 in the car width direction. A pair of V-shaped third grooves 472B is formed on the right end of the first groove 471 in the car width direction. The second grooves 472A and the third grooves 472B are through grooves. The second grooves 472A and the third grooves 472B extend outward from the opposite ends of the first groove 471 in a spreading manner in the front-rear direction. The front one of the two second grooves 472A is located at the boundary between the front-side door portion 43 and the left-side door portion 45. The rear one of the two second grooves 472A is located at the boundary between the rear-side door portion 44 and the left-side door portion 45. The front one of the two third grooves 472B is located at the boundary between the front-side door portion 43 and the right-side door portion 46. The rear one of the two third grooves 472B is located at the boundary between the rear-side door portion 44 and the right-side door portion 46.

The angle α defined by the first groove 471 and each second groove 472A is set to an obtuse angle. The angle β defined by the first groove 471 and each third groove 472B is set to an obtuse angle. Such settings of angles are employed to utilize the force by which a first cleavage groove 121 is torn from the center in the car width direction toward the outer sides to smoothly tear, so that second and third cleavage grooves 122A, 122B are smoothly torn. The cleavage grooves 121, 122A, 122B will be discussed below. In the present embodiment, the angles α and β are all set to 135 degrees.

The retainer 40, which has the above described configuration, is made of, for example, thermoplastic olefin (TPO) by injection molding. As shown in FIG. 5, a plurality of protrusions 432 are formed on the surface of the front-side door portion 43, and a plurality of protrusions 442 are formed on the surface of the rear-side door portion 44. FIG. 5 illustrates one of the protrusions 432 and one of the protrusions 442. Protrusions (not shown) similar to those on the front-side door portion 43 and the rear-side door portion 44 are formed on the surfaces of the first to fourth extended portions 42A, 42B, 42C, 42D, the left-side door portion 45, and the right-side door portion 46. The protrusions 432, 442 are fixed to the back of the base member 11 of the airbag door 50, for example, by vibration-welding.

### <Regarding Tear Line TL>

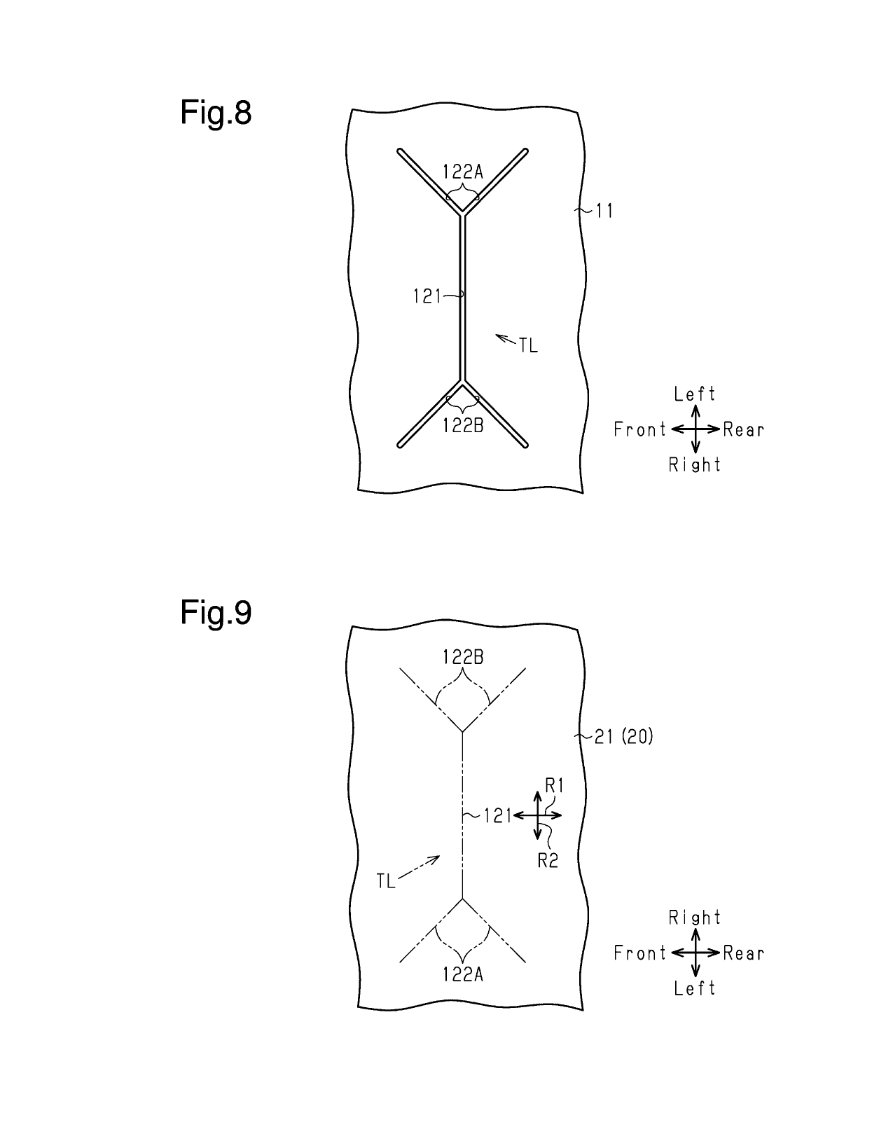

As shown in FIGS. 4, 5, and 8, a tear line TL is formed in the back of the base member 11. As shown in FIG. 8, the tear line TL is formed by a first cleavage groove 121, which extends in the car width direction, a pair of second cleavage groove 122A, which extends from the left end of the first cleavage groove 121, a pair of third cleavage groove 122B, which extends from the right end of the first cleavage groove 121. The tear line TL is located on the top side of the through-groove 47 of the retainer 40. One of the second cleavage grooves 122A extends outward in the car width direction and diagonally forward, and the other second cleavage groove 122A extends outward in the car width direction and diagonally rearward, so that the two second cleavage grooves 122A form a V-shape. One of the third cleavage grooves 122B extends outward in the car width direction and diagonally forward, and the other third cleavage groove 122B extends outward in the car width direction and diagonally rearward, so that the two third cleavage grooves 122B form a V-shape. Thus, the parts of the base member 11 where the first cleavage groove 121, the second cleavage grooves 122A, and the third cleavage grooves 122B are formed are thinner than the remaining parts and have a lower strength. As shown in FIG. 5, the first cleavage groove 121 has a rectangular cross-sectional shape, which is elongated along the thickness of the base member 11. In the present embodiment, the width of the first cleavage groove 121 on the top side is set to 1.0 mm. The second cleavage grooves 122A and the third cleavage grooves 122B each have a similar cross-sectional shape as that of the first cleavage groove 121.

In contrast, the cover member 15 of the present embodiment (the three-dimensionally knitted cushion layer 20) has no cleavage grooves.

As shown in FIGS. 8 and 9, the tear line TL is configured such that the first cleavage groove 121 extends in the direction R2, in which the tensile strength of the three-dimensionally knitted cushion layer 20 is the greatest.

To open the airbag door 50, the tear line TL is pressed by the airbag 62 being deployed and inflated to become the starting point of tearing action of the airbag door 50. The tear line TL is provided for smoothly opening the airbag door 50 and ensuring smooth deployment and inflation of the airbag 62.

In the present embodiment, the tear line TL is configured such that, when the airbag door 50 is pressed by the airbag 62 being deployed and inflated, the first cleavage groove 121 is torn prior to the second cleavage grooves 122A and the third cleavage grooves 122B.

Characteristic features of the present embodiment will now be described.

The mass per unit area of the top-side knitted fabric layer 21 is set to be in the range from 50 g/m² to 500 g/m².

Further, the mass per unit area of the back-side knitted fabric layer 22 is set to be in the range from 150 g/m² to 300 g/m². This is because if the mass per unit area of the back-side knitted fabric layer 22 were less than 150 g/m², the porosity of the back-side knitted fabric layer 22 would be increased so that the adhesive 30 would be likely to leak into the back-side knitted fabric layer 22 and the connection layer 24, and the leaked adhesive 30 might degrade the cushioning property (elasticity) of the three-dimensionally knitted cushion layer 20. On the other hand, if the mass per unit area of the back-side knitted fabric layer 22 were greater than 300 g/m², the tensile strength of the back-side knitted fabric layer 22 would be excessive and hamper smooth tearing of the back-side knitted fabric layer 22.

In the present embodiment, the stretch ratio of the back-side knitted fabric layer 22 is set to be smaller than that of the top-side knitted fabric layer 21.

Operation of the present embodiment will now be described.

Since the mass per unit area of the back-side knitted fabric layer 22, which constitutes the three-dimensionally knitted cushion layer 20, is set to be greater than or equal to 150 g/m², the apertures of the mesh of the back-side knitted fabric layer 22 can be made small enough to prevent the adhesive 30 from leaking out. Thus, the adhesive 30 applied to the back of the back-side knitted fabric layer 22 is prevented from leaking into the connection layer 24 or the top-side knitted fabric layer 21 from the back-side knitted fabric layer 22. Therefore, the cushioning property (elasticity) of the connection layer 24 and the top-side knitted fabric layer 21 is prevented from deteriorating due to leakage of the adhesive 30.

Since the adhesive 30 is prevented from leaking, the amount of the adhesive 30 for stably joining the back-side knitted fabric layer 22 and the base member 11 to each other is reduced.

The greater the mass per unit area of the back-side knitted fabric layer 22, the greater its tensile strength becomes. Accordingly, it may become difficult to stably tear the cover member 15 (the three-dimensionally knitted cushion layer 20) by tearing the base member 11 by the pressing force of the airbag 62 being deployed and inflated.

In this regard, the mass per unit area of the back-side knitted fabric layer 22 is set to be less than or equal to 300 g/m² in the present embodiment. This allows the cover member 15 to be stably torn by tearing the base member 11 by the pressing force of the airbag 62 being deployed and inflated.

The automobile airbag door according to the above described embodiment has the following advantages.

(1) The cover member 15 includes the three-dimensionally knitted cushion layer 20. The three-dimensionally knitted cushion layer 20 includes the top-side knitted fabric layer 21, the back-side knitted fabric layer 22 bonded to the surface of the base member 11, and the connection layer 24, which is configured by the connecting strands 23, which connect the back-side knitted fabric layer 22 and the top-side knitted fabric layer 21 to each other. The mass per unit area of the back-side knitted fabric layer 22 is set to be in the range from 150 g/m² to 300 g/m².

Since such a configuration operates in the above described manner, deterioration of the cushioning property of the cover member 15 due to leakage of the adhesive 30 is restrained, and the cover member 15 is allowed to be stably torn when the airbag apparatus 61 is activated.

(2) The top-side knitted fabric layer 21 constitutes the ornamental surface of the cover member 15.

With this configuration, the ornamentality of the airbag door 50 is improved by the knitting pattern of the top-side knitted fabric layer 21.

In this case, however, if the adhesive 30 leaks from the back-side knitted fabric layer 22 into the connection layer 24 or the top-side knitted fabric layer 21, the leaked adhesive 30 may degrade the appearance of the top-side knitted fabric layer 21, which constitutes an ornamental surface, and the connection layer 24, which can be seen through apertures in the top-side knitted fabric layer 21.

In this regard, the above described configuration is capable of preventing the adhesive 30 from leaking from the back-side knitted fabric layer 22 into the connection layer 24 or the top-side knitted fabric layer 21. This prevents the leaked adhesive 30 from degrading the appearance (ornamentality) of the top-side knitted fabric layer 21, which constitutes an ornamental surface, and the appearance (ornamentality) of the connection layer 24, which can be seen through apertures in the top-side knitted fabric layer 21.

(3) The stretch ratio of the back-side knitted fabric layer 22 is set to be smaller than that of the top-side knitted fabric layer 21.

With this configuration, the stretch ratio of the back-side knitted fabric layer 22, which is arranged closer to the base member 11 than the top-side knitted fabric layer 21, is set to be small. Thus, when the pressing force of the airbag 62 being deployed and inflated tears the base member 11, the relatively less stretchable back-side knitted fabric layer 22 is easily torn. This allows the entire cover member 15 to be torn at an early stage. Therefore, the cover member 15 is torn in a stable manner.

### <Modifications>

The above described embodiment may be modified as follows.

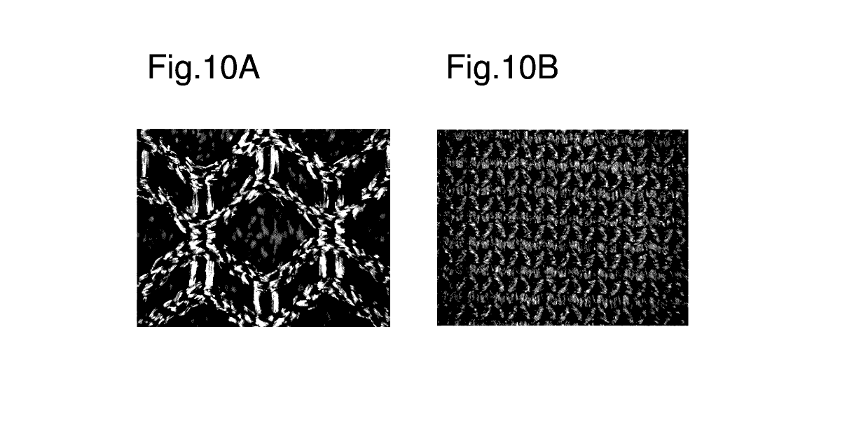

As shown in FIGS. 10A and 10B, the structures (the knitting patterns) of the top-side knitted fabric layer 21 and the back-side knitted fabric layer 22 may be changed, respectively.

The three-dimensionally knitted cushion layer 20 does not necessarily have anisotropy of the tensile strength in directions along its surface.

The top-side knitted fabric layer 21 may have a flat knitted fabric structure. That is, the top-side knitted fabric layer 21 may have a structure of, for example, tricot knitting, cord knitting, or atlas knitting, which are three basic knit constructions of warp knitting.

The first to third cleavage grooves 121, 122A, 122B may each have a trapezoidal cross-sectional shape with the width decreasing toward the top side.

The stretch ratio of the back-side knitted fabric layer 22 may be set to be greater than or equal to that of the top-side knitted fabric layer 21.

A covering layer made of, for example, artificial leather may be provided on the surface of the three-dimensionally knitted cushion layer 20.

1. An automobile airbag door comprising:
a base member having a surface and a back side;
a cover member, which is bonded to the surface of the base member; and
a tear line formed in the back side of the base member, wherein the tear line is configured to be a starting point of tearing when the base member is pressed by an airbag being deployed and inflated, wherein
the cover member includes a three-dimensionally knitted cushion layer,
the three-dimensionally knitted cushion layer includes
a top-side knitted fabric layer,
a back-side knitted fabric layer, which is bonded to the surface of the base member, and
a connection layer, which is configured by connecting strands connecting the back-side knitted fabric layer and the top-side knitted fabric layer to each other, and
a mass per unit area of the back-side knitted fabric layer is set to be in a range from 150 g/m² to 300 g/m².

2. The automobile airbag door according to claim 1, wherein the top-side knitted fabric layer constitutes an ornamental surface of the cover member.

3. The automobile airbag door according to claim 1, wherein a stretch ratio of the back-side knitted fabric layer is set to be smaller than that of the top-side knitted fabric layer.
